(19) United States
(12) Patent Application Publication
(10) Pub. No.: US 2013/0162434 A1
(43) Pub. Date: Jun. 27, 2013

(54) SIGNAL APPARATUS FOR AN ALARM INSTALLATION, ALARM INSTALLATION AND METHOD FOR OPERATING THE SIGNAL APPARATUS

(71) Applicants: Volker Blaschke, Ludwigsburg (DE); Anton Pfefferseder, Sauerlach (DE); Ulrich Oppelt, Zorneding (DE); Muhammed Ali Narin, Haar (DE); Michael Guertner, Hoehenkirchen-Siegertsbrunn (DE)

(72) Inventors: Volker Blaschke, Ludwigsburg (DE); Anton Pfefferseder, Sauerlach (DE); Ulrich Oppelt, Zorneding (DE); Muhammed Ali Narin, Haar (DE); Michael Guertner, Hoehenkirchen-Siegertsbrunn (DE)

(73) Assignee: ROBERT BOSCH GMBH, Stuttgart (DE)

(21) Appl. No.: 13/635,438

(22) PCT Filed: Mar. 14, 2011
(86) PCT No.: PCT/EP2011/053767

§ 371 Date: Feb. 15, 2013

(30) Foreign Application Priority Data
Mar. 17, 2010 (DE) 10 2010 002 940.8

(51) Int. Cl. G08B 17/06

(52) U.S. Cl. CPC G08B 17/06
USPC 340/577

(57) ABSTRACT

Alarm installations in buildings or other environments are used to notify people of particular events, particularly hazards. By way of example, fire alarm installations usually have visual signal generators which, in the event of an alert, bring a hazard situation to the attention of people in a building by means of visual signals. In this case, the aim is to use the visual signals to prompt the people to leave the building via the escape routes. A signal apparatus (1) for an alarm installation (2) is proposed, having a signal generator (3) for outputting a notification signal (6) to the environment of the signal apparatus (1), having a control device (4) for actuating the signal generator (3), and having an activation interface (5) for receiving an activation signal for triggering and/or synchronizing the control apparatus (1), wherein the activation interface (5) is designed to receive a notification signal (6) from a different signal generator than the activation signal.

### BACKGROUND OF THE INVENTION

The invention relates to a signal apparatus for an alarm installation having a signal generator for outputting a notification signal to the environment of the signal apparatus, having a control device for actuating the signal generator and having an activation interface for the reception of an activation signal for triggering and/or synchronizing the control device. The invention also relates to an alarm installation having the signal apparatus and to a method for operating it.

Alarm installations in buildings or other environments are used for notifying persons of special events, particularly hazards. For example, fire alarm installations usually have visual signal generators which, in the case of an alert, bring a hazard situation to the attention of persons in a building by means of visual signals. The aim is in this case to prompt the persons by the visual signals to leave the building via the escape routes. Known constructional forms of the visual signal generators use flash lamps which radiate a very short but very intensive light pulse to the environment. So that the alert covers the entire alert area, several visual signal generators are usually used, the effective ranges of which overlap.

Such a visual external signal generator is described, for example, in the printed document DE 196 322 87 B4.

It is sufficient for the basic operation of the signal generator to apply an enable signal or a supply voltage via a connecting line to the signal generator which thereupon flashes at a preset timing rhythm, e.g. at about one light pulse per second.

It may be problematic, however, that the flashing frequency of different signal generators is different or shifts with time due to component tolerances so that a person standing within the alert area would perceive different light pulses at slightly offset times from different directions. This displacement of the light pulses with respect to one another is unpleasant, on the one hand, and can lead to a confusion of the persons within the alert area in the worst case.

The printed document U.S. Pat. No. 5,886,620, which probably forms the nearest prior art, proposes for this reason an alarm installation in which a synchronizing pulse is communicated via a common power supply line so that the visual signal generators are triggered simultaneously.

### SUMMARY OF THE INVENTION

According to the invention, a signal apparatus for an alarm installation is proposed. The alarm installation comprises in preferred embodiments an alarm center and a bus system via which the alarm center is connected and/or can be connected to at least one signal apparatus. In particular, the signal apparatus is designed as a component of the alarm installation. In particular, the signal apparatus and the alarm center are components in a common communication system. Looked at constructionally, the signal apparatus is preferably implemented as a ceiling- or wall-mounted device.

The signal apparatus comprises a signal generator which is designed for outputting a notification signal to the environment of the signal apparatus. In particular, the notification signal is transmitted cable-independently. The notification signal is preferably designed in such a manner that it can be perceived without further aids by a person. The notification signal can be, for example, a visual, audible or haptic notification signal. In particular, the notification signal is designed in such a manner that it can be transmitted over more than 2 m, preferably over more than 5 m to the person.

The signal apparatus also comprises a control device which is designed for actuating, especially for activating, the signal generator so that it outputs the notification signal.

Furthermore, the signal apparatus has an activation interface for the reception of an activation signal for triggering and/or synchronizing the control device. The activation signal can thus be in the most general type of embodiment an enable signal or a synchronization signal or a triggering signal.

Within the context of the invention, it is proposed that the activation interface is designed for receiving a notification signal from another signal generator, especially from another signal apparatus, as the activation signal.

In comparison with the signal apparatuses from the known prior art, the notification signal is used as activation signal according to the invention which has hitherto been used exclusively for the notification of the persons. The advantage of the invention lies in the fact that the notification signal can be picked up from the environment by the signal apparatus and/or is cablelessly transmittable so that no further installation expenditure is necessary for transmitting the activation signal. In particular, it is proposed to perform the synchronization of signal apparatuses on the basis of the notification signals.

In a particularly preferred embodiment of the invention, the signal apparatus is designed as a visual signal generator for a fire alarm installation as the alarm installation. In this case, it is preferred that the visual signal generator is implemented as a flash lamp, particularly a so-called flash light or strobe. For the reception of the notification signal from the environment, it is preferred that the activation interface has a light-sensitive sensor. In particular, the signal apparatus has a photo receiver as the light-sensitive sensor which receives the light of another signal apparatus, designed as flash lamp, located in the area, which forms the activation signal.

In an advantageous development of the invention, the activation interface has a detection means which is designed for detecting and/or filtering out the notification signal so that only a signal verified as notification signal by the detection means is forwarded as activation signal to the control device. The detection means can be designed, for example, as a visual filter which only allows light to be transmitted which corresponds to the light of the notification signal. As an alternative or additionally, the detection means can perform a time analysis of the received signals and detect, for example, a strong rise in the light intensity due to a light pulse and in this manner detect or verify the notification signal.

In a possible, practical implementation, it can be provided that the signal apparatus is designed in such a manner that it receives the notification signal from another signal generator via the activation interface and immediately sends out its own notification signal. Since a circuit for actuation of the signal generator in the signal apparatus can be designed to be very rapid, the time delay between the reception of the notification signal and output of its own notification signal can be kept very short.

In particular, it is possible that the delay is shorter than 10 milliseconds. This way of transmitting the activation signal is thus adequate for meeting legal requirements for synchronization. Thus, for example, UL 1971 “signaling for the hearing impaired” demands that only 10 milliseconds must lie between the light pulses from different signal generators. Within the context of the objective, simultaneity must thus be assumed.

In a possible extension of the invention, the signal apparatus has an enable interface which is designed for receiving an enable signal, the control device being designed for enabling the signal apparatus in response to the enable signal. This development is based on the consideration that, for avoiding false alarms, it may be appropriate that the signal apparatus is firstly enabled for example via an alarm center and only then can be triggered or synchronized by the activation signal.

It is possible, e.g., that the enable signal represents a first condition and the activation signal represents a second condition for actuating the signal generator so that the signal generator is actuated, particularly activated, when both conditions are met. If both conditions are present, synchronized notification signals are output.

As an alternative or additionally, the signal apparatus is designed in such a manner that the input of an enable signal has the effect that the control device actuates or triggers the signal generator, in particular, regularly, for example at an output frequency within the range of less than 10 Hertz, especially at 1-2 Hertz. By applying the enable signal, the signal apparatus can thus be operated in free-running or unsynchronized manner so that unsynchronized notification signals are output.

In the case of an extension, the signal apparatus can thus be designed for outputting synchronized and unsynchronized notification signals. To prevent too frequent an output of notification signals, it is preferred that the control device has a delay module which is designed for preventing an actuation of the signal generator for a predeterminable time interval. The predeterminable time interval is preferably dimensioned to be shorter than the spacing of the notification signals at the output frequency. Particularly preferably, the predeterminable time interval is started with the output of a notification signal, in special cases only with the output of a synchronized output signal. This development is based on the consideration that the signal apparatus is switched to be passive for the predeterminable time interval and can thus output neither an unsynchronized nor a synchronized notification signal. If an activation signal is present after the time interval, a synchronized notification signal is output and the actuation of the signal generator is prevented for a further time interval by the delay module so that an unsynchronized notification signal cannot be output. If, in contrast, an unsynchronized notification signal is output after the time interval, the delay module has the result that no further synchronized notification signal is output in the subsequent time interval. The delay module thus also ensures that each signal apparatus approximately maintains the illumination rhythm to be expected even in the unsynchronized state.

A further advantage of the signal apparatus can be seen in the fact that the alarm installation, particularly the fire alarm installation, can be expanded very simply. Should there be a further signal apparatus within the range of vision of the signal apparatus, this, too, can be actuated via the notification signal as activation signal. By using the notification signal as activation signal, a multiplicity of signal apparatuses which are located within a mutual visual or effective range can thus be operated synchronously or quasisynchronously. By means of the synchronous operation, a person cannot be influenced or confused by irregular light pulses from different viewing directions regardless of where he or she is located in the alert area.

A further subject matter of the invention relates to an alarm installation, particularly a fire alarm installation, which has at least one signal apparatus. In one preferred embodiment, the alarm installation comprises an alarm center which is designed for transmitting an or the enable signal to the at least one signal apparatus.

A further subject matter of the invention relates to a method for operating the signal apparatus and/or the alarm installation. In the method, it is provided to trigger and/or to synchronize the signal apparatus in response to the reception of a notification signal of another signal generator.

### BRIEF DESCRIPTION OF THE DRAWINGS

Further features, advantages and effects of the invention are obtained from the subsequent description of preferred exemplary embodiments of the invention and the attached figures, in which:

FIG. 1 shows a diagrammatic block representation of a signal apparatus as a first exemplary embodiment of the invention;

FIG. 2 shows a diagrammatic representation of an alarm installation having the signal apparatus in FIG. 1 as a second exemplary embodiment of the invention;

FIG. 3 shows a top view of a building layout with distributed signal apparatuses according to FIG. 1;

FIG. 4 shows a temporal plot of the offset of flash pulses and their synchronization of signal apparatuses according to FIG. 1 or FIG. 2, respectively.

### DETAILED DESCRIPTION

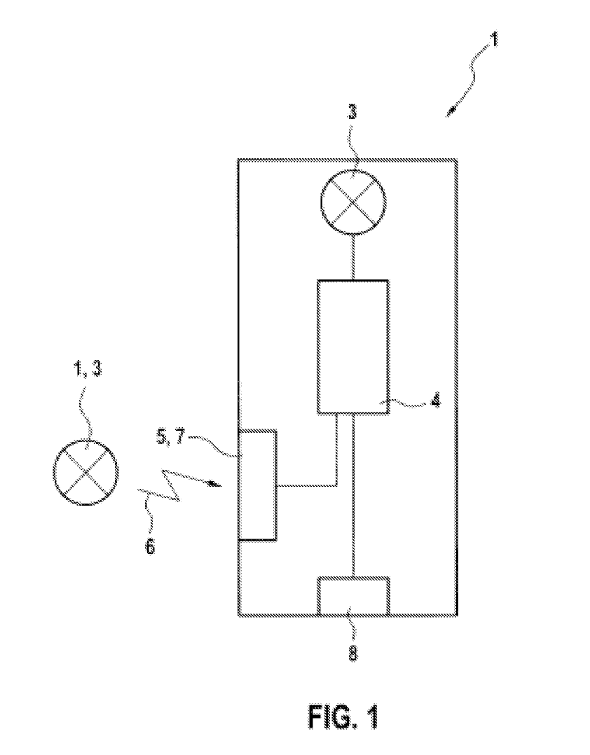

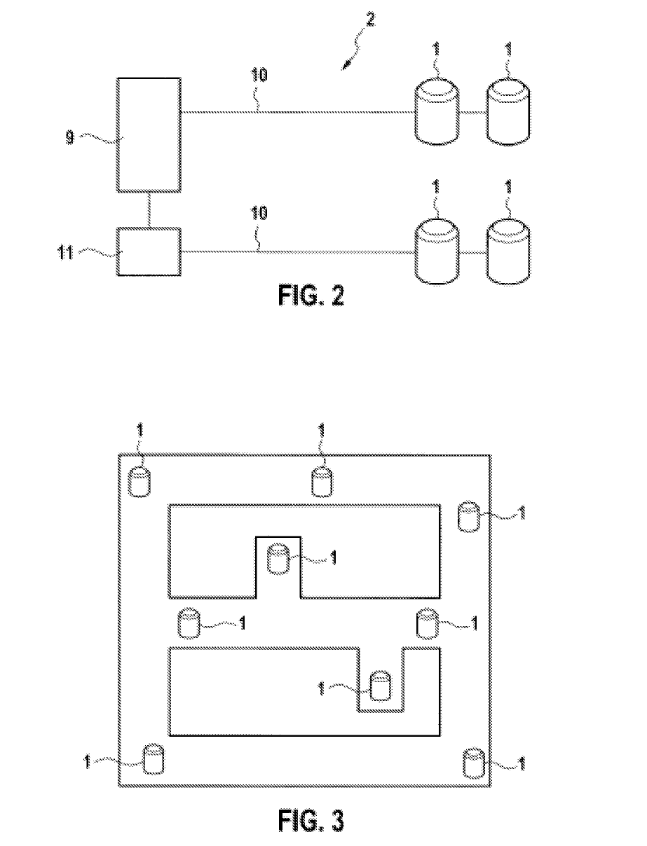

FIG. 1 shows in a diagrammatic block representation a signal apparatus 1 which is suitable and/or designed for use in a fire alarm installation 2 (FIG. 2). The signal apparatus 1 is designed as a visual signal device which in the case of an alert sends out light pulses or flashes as notification signals to the environment in order to warn persons in the environment. The signal apparatus 1 has a signal generator in the form of a flash lamp 3 which is also called flash light or strobe in technical language. The flash lamp 3 allows a short but intensive light pulse to be radiated out as notification signal to the environment. The intensity of the light radiation is deliberately high in order to underline the impression of a hazard situation in every case. As can be seen from the representation in FIG. 2, the signal apparatus 1 can have a cylindrical housing.

To actuate the flash lamp 3, the signal apparatus 1 has a control device 4 which, in particular, comprises the flash electronics and is designed for activating the flash lamp 3. To trigger the flash lamp 3 or to synchronize it with other signal apparatuses 1, the signal apparatus 1 has an activation interface 5 which is designed for receiving a notification signal 6 of another signal apparatus 1 or another flash lamp 3 as activation signal. For the reception of the notification signal, the activation interface 5 comprises, e.g., a photosensitive element 7. The notification signal 6 is designed as another light pulse in the example shown. In modified embodiments, the notification signal 6 can also be, for example, an audible signal and the activation interface can comprise a microphone.

Optionally additionally, the signal apparatus 1 comprises an enable interface 8 via which an enable signal can be transmitted by a higher-level controller to the signal apparatus 1 which comprises general enabling for sending out a notification signal.

FIG. 2 shows in an also diagrammatic block representation the fire alarm installation 2 which comprises a plurality of signal apparatuses 1 according to FIG. 1 and an alarm center 9. The alarm center 9 can be, on the one hand, a center occupied by monitoring personnel or an automated alarm center 9, especially in the form of a data processing device. The signal apparatuses 1 are connected to the alarm center 9 via a bus 10, especially a field bus or safety bus. If necessary, other network components 11 such as, for example, interfaces, repeaters or the like can be interconnected. In addition, it is also possible that other types of signal apparatuses such as, for example, notification signs, sirens etc. are connected to the bus 10. As an alternative to this, alarm center 9 and signal apparatuses 1 are connected to one another with respect to signals via a direct wiring.

In the case of an alarm, an enable signal is transmitted from the alarm center 9 to the signal apparatuses 1 via the bus 10. The further synchronization or triggering of one another is carried out via the notification signals 6 sent out by the signal apparatuses 1, which signals can be received via the activation interfaces 5.

FIG. 3 shows a diagrammatic top view of a building layout with a plurality of signal apparatuses 1, wherein this image is intended to illustrate that the notification signals 6 can possibly be transmitted to each signal apparatus 1 by wall reflections. No especially high demands are made on the spatial distribution of the signal apparatus 1.

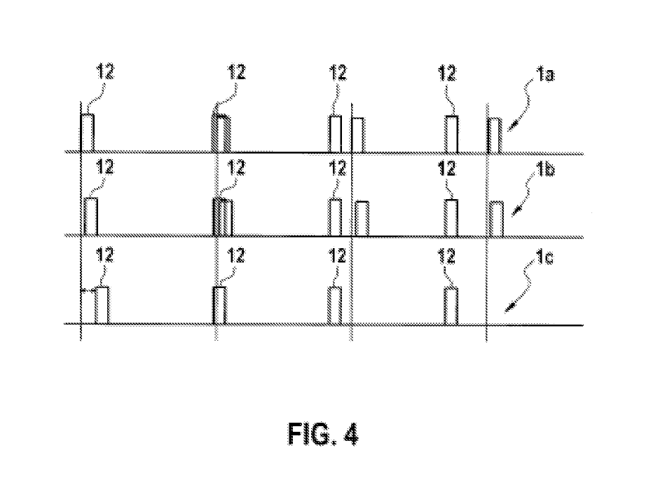

FIG. 4 shows the offset of flash pulses with time of three different signal apparatuses 1a, 1b and 1c to illustrate the operation of the fire alarm installation 2 or of the signal apparatuses 1, respectively. The signal apparatuses 1 to be actuated in each case are enabled via the alarm center 9 by an enable signal which is transmitted to the enable interface 8 via the bus 10. Following the enable signal, all signal apparatuses deliver a flash pulse 12, wherein the flash pulses 12 have a time offset which is slight, but insignificant for human perception, due to line propagation times and other switching times. The activation via the activation interface 5 is not yet effective at the beginning because the enable signal, which is not yet available due to the electrical propagation times at the other signal apparatuses 1b, 1c, prevents triggering when the first signal apparatus 1a is triggered.

The control device 4 now begins to actuate a notification signal 6 regularly, usually with a time interval of 1 s to 2 s. The first signal apparatus 1 which is the first one to be triggered again due to the various tolerances—the signal apparatus 1c in this case—thereupon again delivers a notification signal 6 in the form of a flash pulse 12. This flash pulse 12 triggers the further signal apparatuses 1a, b in the visual zone of influence of the signal apparatus 1c via the activation interface 5 so that these are triggered almost simultaneously. Other signal apparatuses which are within the visual zone of influence of the signal apparatuses 1a and 1b are also triggered by the transmission chain now produced. Due to the very short switching times, it thus appears as if all signal apparatuses have been triggered at the same time. The process is then repeated periodically with the duration of a period of the signal apparatus 1 having the shortest running internal timing generator.

It is also advantageous that when, due to a further alarm event, further signal apparatuses 1 are to be added, these now only need the enable signal and have been automatically included in the synchronization after a flash period.

In order to avoid false triggering by other light sources or interfering influences, technical measures can be used. Thus, an electrical edge filter, for example a high-pass filter with suitable edge steepness, can be used for responding only to the characteristic edge of a flash lamp pulse. In principle, the evaluation of characteristic visual signatures in the flash signal for preventing false triggering is also conceivable. Furthermore, the triggering of a further flash after one triggering can be prevented for a certain time until a minimum time for a new enabling of a flash has elapsed. This time can be slightly shorter than the shortest permissible time of a period of the sequence of flashes.

1. A signal apparatus for an alarm installation, the apparatus comprising:
a signal generator for outputting a notification signal to the environment of the signal apparatus,
a control device for actuating the signal generator, and
an activation interface for the reception of an activation signal for triggering and/or synchronizing the control apparatus, wherein
the activation interface is designed for receiving a notification signal from another signal generator as the activation signal.

2. The signal apparatus as claimed in claim 1,
wherein the signal apparatus is designed with a visual signal generator.

3. The signal apparatus as claimed in claim 1,
wherein the activation interface has a light-sensitive sensor which is designed for receiving a visual notification signal from another signal generator.

4. The signal apparatus as claimed in claim 3,
wherein the activation interface has a detection means which is designed for detecting and/or filtering out the notification signal.

5. The signal apparatus as claimed in claim 1, further comprising an enable interface for the reception of an enable signal, wherein the control device is designed for actuating and/or triggering the signal generator.

6. The signal apparatus as claimed in claim 1, wherein the control device has a delay module which is designed for preventing an actuation of the signal generator for a predeterminable time interval.

7. An alarm installation, particularly a fire alarm installation, characterized by at least one signal apparatus as claimed in claim 1.

8. The alarm installation as claimed in claim 7, further comprising an alarm center, wherein the alarm center is designed for transmitting an or the enable signal to the at least one signal apparatus.

9. A method for operating the signal apparatus and/or the alarm installation as claimed in claim 1, wherein the signal apparatus is triggered and/or synchronized in response to the reception of a notification signal of another signal generator.

10. The method as claimed in claim 9, wherein further signal apparatuses are triggered and/or synchronized by communication of the notification signal of the signal apparatus.
